(19) United States
(12) Patent Application Publication
(10) Pub. No.: US 2002/0023592 A1
(43) Pub. Date: Feb. 28, 2002

(54) Cattle conveying system for dairy parlors

(76) Inventor: Steve N. Peacock, Portales, NM (US)

Correspondence Address: SHOEMAKER AND MATTARE, LTD., Crystal Plaza Building 1 - Suite 1203, 2001 Jefferson Davis Highway, Arlington, VA, 22202, US

(21) Appl. No.: 09/941,673

(22) Filed: Aug. 30, 2001

Related U.S. Application Data
(60) Provisional application No. 60/228,753, filed on Aug. 30, 2000.

(51) Int. Cl. A01J 3/00

(52) U.S. Cl. 119/14.03

(57) ABSTRACT

Groups of cows are transported by wheeled conveyances to and from a milking station in a dairy parlor. Cows are loaded onto the conveyances, and are discharged therefrom, at locations on either side of the milking station. This avoids having to herd cows into and out of the milking station, maximizing milking equipment utilization.

This application claims priority from provisional patent application 60/228753, filed Aug. 30, 2000.

### BACKGROUND OF THE INVENTION

This invention relates to a cattle conveying system for dairy parlors.

Milking large herds of cows is a time-consuming process. A very substantial portion of the process is the effort of getting the cows into and out of the milking pit. While cows are entering and exiting the milking area, the milkers are idle. One could improve the utilization of the milkers by minimizing the cow loading and unloading times. One could also improve conditions for both the dairy workers and the cows by moving the cows in a more organized fashion to and from the milkers.

Prior inventors have addressed the problem of moving cows through a dairy parlor. Representative prior patents include U.S. Pat. Nos. 1,987,955, 3,282,250, 3,402,699, 3,460,515, 3,759,225, 3,810,442, 4,261,292 and 4,323,033.

### SUMMARY OF THE INVENTION

An object of the invention is to improve the speed of milking dairy cows.

Another object is to relieve dairy workers of some of the burden of loading dairy cows for milking. A related object is to reduce the stress of the milking process on the cows.

These and other objects are attained by a cattle conveying system for dairy parlors, comprising a milking station having milking equipments and a pair of loading stations on either side of the milking station, and a movable conveyance for transporting cows between the loading station and the milking station, so that the cows do not have to be herded in and out of the milking station.

### BRIEF DESCRIPTION OF THE DRAWINGS

In the accompanying drawings,

FIG. 1 is a diagrammatic top plan view of a cattle conveying system for dairy parlors embodying the invention.

### DESCRIPTION OF THE PREFERRED EMBODIMENT

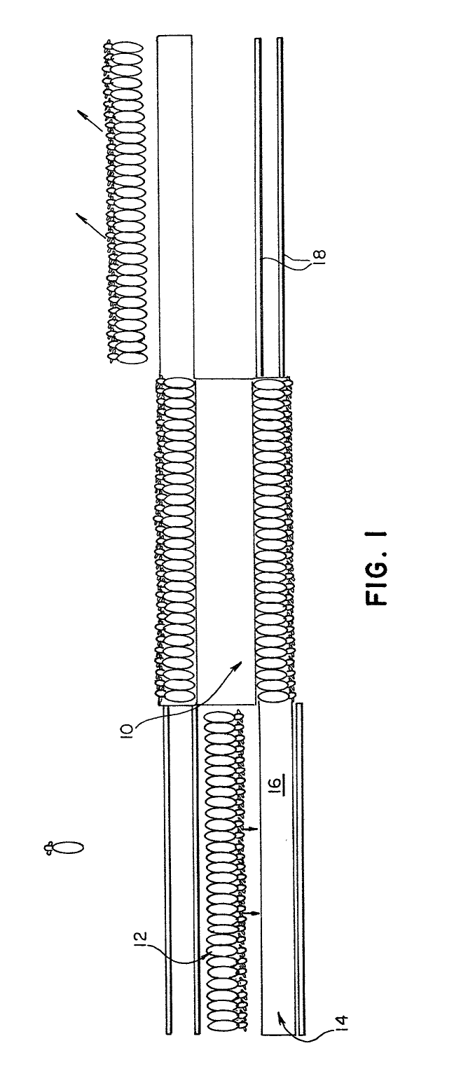

A cattle conveying system embodying the invention includes a milking station 10 (FIG. 1) comprising milking equipment (not shown), a pair of loading stations 12, 12′ on either side of the milking station, and a movable conveyance 14 for transporting cows between the loading station and the milking station 10. The conveyance includes a platform 16 which rides on a pair of tracks 18. The wheels on the bottom of the platform are not visible in this view.

The platform is long enough to span the milking station and only one of the loading stations, so that it can be shuttled back and forth between loading stations, and a portion of the platform will always be present at the milking station.

The conveyances are shuttled back and forth on the tracks by a drive mechanism, not shown, which may be activated manually or automatically. Particularly in the latter case, adequate safeguards should be provided to avoid premature activation.

FIG. 1 shows a first group of cows in the milking station, and a second group standing at the loading station 12. While the first group are being milked, the second group are induced to walk onto the platform. When the milking of the first group is complete, and the second group are standing on the platform at the loading station, the drive mechanism is activated so as to move the platform to the right, rapidly carrying the loaded cows to the milking equipment, and simultaneously moving the just-milked cows to the loading station 12′, where they are permitted or encouraged to leave the platform. Now a third group of cows are assembled on the platform at station 12′, and at the proper time, the platform is driven to the left, returning the second group to the loading station when they came and readying the third group for milking. This process, which alternates the loading stations, is repeated indefinitely as long as necessary. The idle time of the milking equipment is thus substantially reduced; that is, its utilization is maximized.

The drawing shows two pairs of tracks, one on either side of the milking pit. This arrangement is preferred, but not required. The operation of the conveyances on the respective tracks is the same, but independent: the conveyances needed not move in synchronization. It should be understood that a single set of tracks and a single conveyance, or more than two pairs of tracks and a corresponding number of conveyances are within the inventive concept described.

It should also be appreciated that a wheeled platform riding on tracks is but one type of conveyance which might be used to move the cows about. Other suitable devices will occur to those or ordinary skill in the field of this invention, and it is intended that any such conveyance for cows may be used according to this invention. Also, the path followed by the conveyance need not be a straight line.

Since the invention is subject to modifications and variations, it is intended that the foregoing description and the accompanying drawings shall be interpreted as only illustrative of the invention defined by the following claims.

I claim:

1. A cattle conveying system for dairy parlors, said system comprising
a milking station,
at least two loading stations, one on either side of the milking station, and
at least one movable conveyance spanning the milking station and only one of said loading stations at a time, for transporting cows between the loading stations and the milking station.

2. The invention of claim 1, wherein the conveyance includes a platform which rides on a pair of tracks.

3. The invention of claim 2, comprising two pairs of tracks, one on either side of the milking station, each pair of tracks having a respective conveyance, whereby cows may be loaded onto one of the conveyances while cows on the other conveyance are being milked.

4. The invention of claim 1, wherein said tracks extend between said loading stations, the loading stations being disposed either side of the milking station, so that cows may be loaded on a conveyance at one loading station, then milked at the milking station, and then unloaded from the conveyance at the same loading station.

5. A method of moving cows through a milking parlor having a milking station and at pair of loading stations, one on either side of the milking station, said method comprising steps of
loading a first group of cows onto a first end of a conveyance at a first loading station,
shuttling the conveyance in a first direction so that its first end is disposed at the milking station,
milking the first group of cows at the milking station while the cows remain on the conveyance, while
loading a second group of cows onto a second end of the conveyance at a second loading station, then
shuttling the conveyance in a second direction opposite said first direction so as to remove the first group of cows from the milking station while delivering the second group of cows to the milking station,
removing the first group of cows from the conveyance, and
loading a third group of cows onto the conveyance while the second group of cows are being milked.
